(19) United States
(12) Patent Application Publication
(10) Pub. No.: US 2014/0213751 A1
(43) Pub. Date: Jul. 31, 2014

(54) EPOXY COMPOSITION AND EPOXY RESIN MOLDED ARTICLE

(71) Applicant: Nitto Denko Corporation, Osaka (JP)

(72) Inventors: Saori FUKUZAKI, Osaka (JP); Seiji IZUTANI, Osaka (JP); Miho YAMAGUCHI, Osaka (JP)

(73) Assignee: Nitto Denko Corporation, Osaka (JP)

(21) Appl. No.: 14/169,313

(22) Filed: Jan. 31, 2014

(30) Foreign Application Priority Data
Jan. 31, 2013 (JP) 2013-017070
Jan. 31, 2013 (JP) 2013-017086

(51) Int. Cl. C08G 59/62

(52) U.S. Cl. CPC C08G 59/621
USPC 528/89; 528/94

(57) ABSTRACT

The present invention provides an epoxy resin molded article excellent in thermal conductivity and an epoxy composition suitable for forming such an epoxy resin molded article. Namely, the present invention relates to an epoxy composition containing an epoxy monomer having a mesogenic skeleton and a phenolic curing agent having a triphenyl methane structure.

### FIELD OF THE INVENTION

The present invention relates to an epoxy composition and an epoxy resin molded article, and more particularly relates to an epoxy composition including a curing agent together with an epoxy monomer and an epoxy resin molded article formed from the epoxy composition.

### BACKGROUND OF THE INVENTION

Epoxy compositions including epoxy monomers and curing agents have hitherto been widely used as materials for cured materials thereof to form molded articles such as semiconductor packages and electrical insulating materials.

In recent years, the epoxy resin molded articles such as semiconductor packages and electrical insulating materials have been required to exert excellent thermal conductivity, and inorganic fillers excellent in thermal conductivity such as boron nitride and aluminum oxide have been blended in the epoxy compositions to be used for formation of the epoxy resin molded articles.

In the epoxy compositions of this kind, it becomes possible to form the epoxy resin molded articles more excellent in thermal conductivity by higher filling with the inorganic fillers. However, when the inorganic fillers are excessively contained, there is a concern that mechanical characteristics of the epoxy resin molded articles are impaired.

From such a situation, it has been tried to improve the thermal conductivity of epoxy resins themselves, compared to that of conventional epoxy resins.

For example, the following Patent Document 1 describes that in order to form an epoxy resin molded article having high thermal conductivity, an epoxy monomer having a mesogenic skeleton is used, followed by applying a high magnetic field in one direction to form the epoxy resin molded article.

Such an epoxy resin having a mesogenic skeleton easily forms a crystallized part in which molecular chains are regularly arranged, in the molded article, and the crystallized part shows high thermal conductivity compared to the other amorphous part. This epoxy resin is therefore advantageous compared to common epoxy resins, in forming the epoxy resin molded article excellent in thermal conductivity.

However, from the viewpoint of productivity and the like of the epoxy resin molded article, it is unfavorable to allow the epoxy resin molded article to exert excellent thermal conductivity by the specific production method as described in Patent Document 1.

Patent Document 1: Japanese Patent No. 4414674

### SUMMARY OF THE INVENTION

An object of the invention is to provide an epoxy composition suitable for forming an epoxy resin molded article that can exert excellent thermal conductivity without significant limitation of a production method thereof.

In order to solve the above-mentioned problem, the present invention relates to the following items 1 to 5.

1. An epoxy composition including:

at least one epoxy monomer selected from the group consisting of epoxy monomers represented by the following general formulae (1) to (4); and

a phenolic curing agent represented by the following general formula (5) or a phenolic curing agent represented by the following general formula (6),

G—X¹—A—X²—G (1)

G—X³—A—X⁴—A′—X⁵—G (2)

G—X⁶—A′—X⁷—A—X⁸—G (b 3)

G—X⁹—A—X¹⁰—A—X¹¹—G (4)

in which G represents a glycidyloxy group, X¹ to X¹¹ each represents a substituted or unsubstituted phenylene represented by the following general formula (x), and X¹ to X¹¹ may be the same or different from one another,

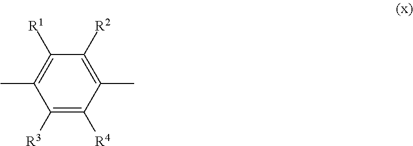

in which R¹ to R⁴ are each a methyl group, an ethyl group, a propyl group or a hydrogen atom, and R¹ to R⁴ may be the same or different from one another, and

further, A and A′ represent azomethine groups represented by the following general formulae (a) and (a′), respectively,

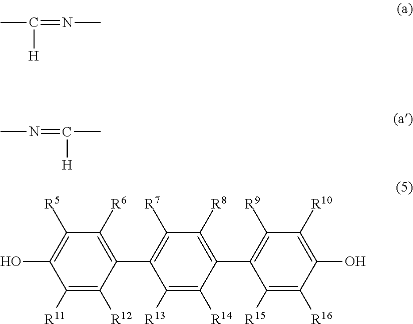

in which R⁵ to R¹⁶ are each a methyl group, an ethyl group, a propyl group or a hydrogen atom, at least one of R⁵ to R¹⁶ is any one of a methyl group, an ethyl group and a propyl group, and R⁵ to R¹⁶ may be the same or different from one another,

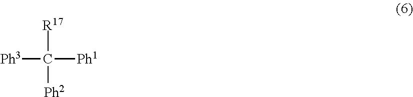

in which R¹⁷ is a hydroxyl group, a methyl group, an ethyl group, a propyl group or a hydrogen atom, Ph¹, Ph² and Ph³ each represents substituted phenyl represented by the following general formula (p), and Ph¹ to Ph³ may be the same or different from one another,

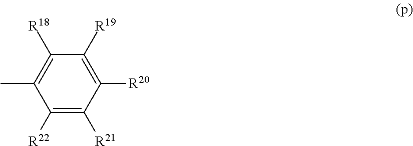

in which R¹⁸ to R²² are each a hydroxyl group, a methyl group, an ethyl group, a propyl group or a hydrogen atom, and at least one of R¹⁸ to R²² is a hydroxyl group.

2. The epoxy composition according to item 1, further including an onium salt-based curing accelerator.

3. The epoxy composition according to item 1 or 2, in which the epoxy monomer is one represented by the general formula (2), (3) or (4).

4. The epoxy composition according to item 2 or 3, in which the onium salt-based curing accelerator is a phosphonium salt-based curing accelerator.

5. An epoxy resin molded article formed from the epoxy composition according to any one of items 1 to 4.

An epoxy composition of the invention includes a specific epoxy monomer together with a specific curing agent, so that a cured material excellent in molecular orientation due to the curing agent and the epoxy monomer and having high thermal conductivity can be formed.

According to the invention, therefore, an epoxy resin molded article excellent in thermal conductivity can be formed.

### DETAILED DESCRIPTION OF THE INVENTION

A preferred embodiment of the invention will be described below.

The epoxy resin molded article in the present embodiment includes, as a main component, an epoxy resin in which epoxy monomers each having an azomethine group (—CH═N—) are bonded to one another by a specific curing agent.

The epoxy resin molded article in the present embodiment exerts an excellent thermal conductivity of 0.3 W/(m·K) or more, in a state where it includes only the epoxy resin free from an inorganic filler and the like.

Further, the epoxy resin molded article in the present embodiment exerts the excellent thermal conductivity as described above without performing a special operation such as application of a high magnetic field at the time of production thereof.

The epoxy composition used for formation of this epoxy resin molded article includes the epoxy monomer having an azomethine group and the phenolic curing agent.

A cured material obtained by curing this epoxy composition contains crystallized parts in which molecular chains are regularly arranged in one direction in a greater ratio than a cured material obtained from an ordinary epoxy resin, because the above-mentioned epoxy monomer has an azomethine group, so that heat can be efficiently conducted in the above-mentioned molecular chain direction.

In forming the epoxy resin molded article excellent in thermal conductivity, it is important to use at least one of epoxy monomers represented by the following general formulae (1) to (4), as the epoxy monomer. These epoxy monomers may be used alone or as a combination of two or more thereof.

G—X¹—A—X²—G (1)

G—X³—A—X⁴—A′—X⁵—G (2)

G—X⁶—A′—X⁷—A—X⁸—G (3)

G—X⁹—A—X¹⁰—A—X¹¹—G (4)

in which G represents a glycidyloxy group, X¹ to X¹¹ each represents a substituted or unsubstituted phenylene represented by the following general formula (x), and X¹ to X¹¹ may be the same or different from one another.

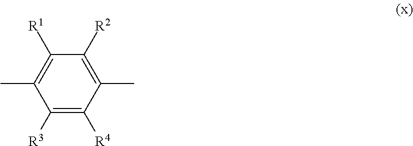

in which R¹ to R⁴ are each a methyl group, an ethyl group, a propyl group or a hydrogen atom, and R¹ to R⁴ may be the same or different from one another.

Further, A and A′ represent azomethine groups represented by the following general formulae (a) and (a′), respectively.

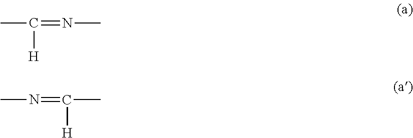

Incidentally, when any one of the above-mentioned R¹ to R⁴ is a propyl group, it may be either a normal propyl group or an isopropyl group.

Of the epoxy monomers represented by the above-mentioned general formulae (1) to (4), preferred are the epoxy monomers represented by the general formulae (2) to (4), each of which has two or more azomethine groups in the molecule thereof.

Preferred examples of the epoxy monomers contained in the epoxy composition of the present embodiment include terephthalylidene-bis-(4-amino-3-methylphenol) diglycidyl ether and terephthalylidene-bis-(p-aminophenol) diglycidyl ether.

Incidentally, the epoxy resin having a mesogenic skeleton can form a liquid crystal state in which mesogenic skeleton parts are regularly arranged, in a predetermined temperature region, and is excellent in that many crystallized parts excellent in thermal conductivity can be formed in the epoxy resin molded article.

Accordingly, the above-mentioned epoxy monomer having two or more azomethine groups in the molecule thereof can introduce many mesogenic structures containing azomethine groups as main parts into the epoxy resin in which the epoxy monomers are bonded to one another, and is excellent in that the epoxy resin molded article excellent in thermal conductivity can be formed.

Examples of the above-mentioned liquid crystal states include nematic, smectic, cholesteric and discotic phases.

These liquid crystal states can be confirmed in development of liquid crystal-specific strong birefringence by normal polarimetry using an orthogonal polarizer.

Of the liquid crystal states developed by the epoxy resins, the smectic phase can exert particularly excellent thermal conductivity, so that the epoxy resin that develops the smectic phase is preferred.

The epoxy resin that develops the smectic phase can be easily obtained by bonding the epoxy monomers each having the mesogenic skeleton containing an azomethine group as a main part to one another by the above-mentioned curing agent.

Further, the epoxy composition may contain an epoxy monomer having another mesogenic skeleton other than the mesogenic skeleton containing an azomethine group as a main part, as needed.

Specific examples of the other mesogenic skeletons include biphenyl, cyanobiphenyl, terphenyl, cyanoterphenyl, phenyl benzoate, azobenzene, azoxybenzene, stilbene, phenylcyclohexyl, biphenylcyclohexyl, phenoxyphenyl, benzylideneaniline, benzyl benzoate, phenylpyrimidine, phenyldioxane, benzoylaniline, tolan and derivatives thereof.

Furthermore, the above-mentioned epoxy resin in the present embodiment may have a flexible structure part called a flexible chain (spacer), which contains an aliphatic hydrocarbon group, an aliphatic ether group, an aliphatic ester group, a siloxane bond or the like, between the above-mentioned epoxy monomers each having the mesogenic skeleton containing an azomethine group as a main part.

As the above-mentioned phenolic curing agent used for bonding the above-mentioned epoxy monomers to one another, it is important to use a phenolic curing agent having a 4,4″-dihydroxy-p-terphenyl structure represented by the following general formula (5) or a phenolic curing agent represented by the following general formula (6), for forming the epoxy resin molded article excellent in thermal conductivity.

First, the phenolic curing agent represented by general formula (5) will be described below:

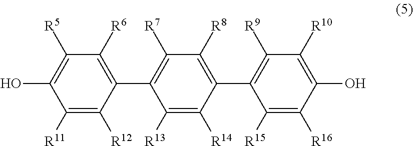

in which R⁵ to R¹⁶ are each a methyl group, an ethyl group, a propyl group or a hydrogen atom, at least one of R⁵ to R¹⁶ is any one of a methyl group, an ethyl group and a propyl group, and R⁵ to R¹⁶ may be the same or different from one another.

Incidentally, when any one of the above-mentioned R⁵ to R¹⁶ is a propyl group, it may be either a normal propyl group or an isopropyl group.

Incidentally, in the phenolic curing agent represented by the above-mentioned formula (5), it is preferred that only one methyl, ethyl or propyl group is bonded to one of two phenyl groups to each of which a hydroxyl group is bonded. Preferred examples thereof include 4,4″-dihydroxy-3″-methyl-p-terphenyl, 4,4″-dihydroxy-2″-methyl-p-terphenyl, 4,4″-dihydroxy-3″-ethyl-p-terphenyl, 4,4″-dihydroxy-2″-ethyl-p-terphenyl, 4,4″-dihydroxy-3″-n-propyl-p-terphenyl, 4,4″-dihydroxy-2″-n-propyl-p-terphenyl, 4,4″-dihydroxy-3″-isopropyl-p-terphenyl and 4,4″-dihydroxy-2″-isopropyl-p-terphenyl.

Above all, 4,4″-dihydroxy-3″-methyl-p-terphenyl shown in the following chemical formula (7) is particularly preferred.

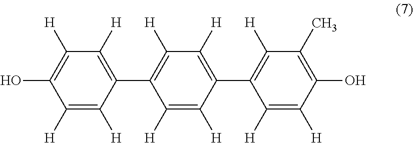 [SMILES: Cc1cc(-c2ccc(-c3ccc(O)cc3)cc2)ccc1O]

The phenolic curing agent represented by general formula (6) will be described below:

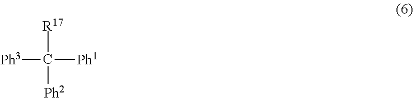

in which R¹⁷ is a hydroxyl group, a methyl group, an ethyl group, a propyl group or a hydrogen atom, Ph¹, Ph² and Ph³ each represents substituted phenyl represented by the following general formula (p), and Ph¹ to Ph³ may be the same or different from one another.

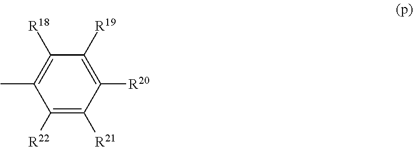

in which R¹⁸ to R²² are each a hydroxyl group, a methyl group, an ethyl group, a propyl group or a hydrogen atom, and at least one of R¹⁸ to R²² is a hydroxyl group.

Incidentally, as the phenolic curing agent represented by the above-mentioned general formula (6), it is preferred that the hydroxyl group number of each phenyl (each of Ph¹ to Ph³) is 1 or 2.

Further, as the phenolic curing agent represented by the above-mentioned general formula (6), it is preferred that each phenyl has no substituent group other than the hydroxyl group (other than the hydroxyl group are preferably hydrogen atoms).

That is to say, the phenolic curing agent represented by the above-mentioned general formula (6) in the present embodiment is preferably 4,4′,4″-methylidynetrisphenol or the like.

Depending on the compounding ratio thereof to the above-mentioned epoxy monomer, the presence or absence of other compounding materials such as a curing accelerator, and the like, it becomes possible that the epoxy composition of the present embodiment forms a cured material showing a glass transition temperature as high as 150° C. or more, by using the preferred phenolic curing agents as described above.

That is to say, in order to obtain the epoxy resin molded article excellent in thermal conductivity, it is preferred to use the phenolic curing agent represented by chemical formula (7) or the phenolic curing agent such as 4,4′,4″-methylidynetrisphenol for the epoxy composition of the present embodiment.

Usually, the above-mentioned phenolic curing agent can be contained in the epoxy composition so that the hydroxyl group number of the phenolic curing agent becomes appropriately equivalent to the glycidyl group number of the above-mentioned epoxy monomer (for example, a ratio between 0.8 and 1.25).

Incidentally, the epoxy composition of the present embodiment may contain another phenolic curing agent, an amine-based curing agent, an acid anhydride-based curing agent, a polymercaptan-based curing agent, a polyaminoamide-based curing agent, an isocyanate curing agent, a block isocyanate-based curing agent or the like within the range where the effect of the invention is not significantly impaired, as needed.

Further, the epoxy composition of the present embodiment preferably contains a curing accelerator together with the above-mentioned phenolic curing agent. Above all, it is preferred that an onium salt-based curing accelerator such as a phosphonium salt-based curing accelerator or a sulfonium salt-based curing accelerator is contained.

Many of the phenolic curing agents and epoxy monomers shown above have a softening point exceeding 200° C., so that the curing accelerator to be contained in the epoxy composition is preferably an accelerator that does not excessively exert catalytic activity at a temperature of 200° C. or less.

Because of this, it is particularly preferred that the phosphonium salt-based curing accelerator such as a tetraphenylphosphonium salt-based curing accelerator or a triphenylphosphonium salt-based curing accelerator is contained as the above-mentioned onium salt-based curing accelerator in the epoxy composition of the present embodiment, and it is most preferred that tetraphenylphosphonium tetraphenyl borate is contained.

Usually, the onium salt-based curing accelerator such as tetraphenylphosphonium tetraphenyl borate can be contained in the epoxy composition so that the ratio thereof to 100 parts by mass of the epoxy monomer is from 0.1 parts by mass to 5 parts by mass.

In order to improve the thermal conductivity of the epoxy resin molded article, it is also possible to blend an inorganic filler excellent in thermal conductivity or the like in proper amounts in the epoxy composition of the present embodiment.

Examples of the inorganic fillers include granular materials, tabular materials and fibrous materials which include metals, metal oxides, metal nitrides, metal carbides, metal hydroxides, carbons, or metal-coated resins.

Examples of the above-mentioned metals include silver, copper, gold, platinum and zirconium, examples of the metal oxides include aluminum oxide and magnesium oxide, examples of the metal nitrides include boron nitride, aluminum nitride and silicon nitride, examples of the metal carbides include silicon carbide, examples of the metal hydroxides include aluminum hydroxide and magnesium hydroxide, and examples of the carbons include carbon blacks, graphites, carbon nanotubes and carbon nanohorns.

When the above-mentioned inorganic filler is contained in the epoxy composition of the present embodiment, the inorganic filler can be usually contained so that the volume ratio of the above-mentioned inorganic filler to the cured material of the epoxy composition becomes 30% by volume to 90% by volume.

In the epoxy composition of the present embodiment, boron nitride particles particularly excellent in thermal conductivity are preferably contained as the above-mentioned inorganic filler.

Further, it is also possible that a pigment, a dye, a fluorescent brightener, a dispersing agent, a stabilizer, a UV absorber, an antistatic agent, an antioxidant, a flame retardant, a thermal stabilizer, a lubricant, a plasticizer, a solvent or the like is appropriately contained in the epoxy composition, as needed.

The epoxy resin molded article in the present embodiment can be formed by subjecting only the epoxy composition as described above or the epoxy composition together with another member to injection molding or press molding, followed by performing post-processing as needed.

Further, the epoxy resin molded article in the present embodiment can be formed by heating the epoxy composition at a temperature equivalent to or higher than the curing reaction initiation temperature thereof to cure it, at the time of the molding as described above.

Then, a site formed by the cured material of the above-mentioned epoxy composition can exert the excellent thermal conductivity.

The epoxy resin molded article of the present embodiment exerts the excellent thermal conductivity, even when a special operation such as application of a high magnetic field is not performed at the time of production. However, in order to further improve the thermal conductivity, orientation of the epoxy resin may be improved by application of the magnetic field.

Specific examples of the epoxy resin molded articles include heat radiating members and insulating materials such as printed circuit boards, semiconductor packages, encapsulation materials, housings, heat pipes, radiator plates, thermal diffusion plates and adhesives. However, the epoxy resin molded article of the invention should not be construed as being limited thereto.

Further, in the epoxy composition and epoxy resin molded article of the invention, conventionally known technical matters can be appropriately adopted within a range not remarkably impairing the effect of the invention, and the invention should not be construed as being limited to the above-mentioned embodiments.

### EXAMPLES

The invention will be described in further detail below with reference to examples, but the invention should not be construed as being limited thereto.

### Example 1

Terephthalylidene-bis-(4-amino-3-methylphenol) diglycidyl ether (DGETAM, epoxy equivalent: 228) and 4,4″-dihydroxy-3″-methyl-p-terphenyl (DHTP-M, hydroxyl group equivalent: 138) were dissolved in methyl ethyl ketone (MEK) so that the ratio of the number of epoxy groups derived from DGETAM to the number of hydroxyl groups derived from DHTP-M was 1:1 to prepare a solution, and tetraphenylphosphonium tetraphenyl borate was added to the solution so that the ratio thereof to 100 parts by mass of DGETAM was 1 part by mass to prepare an epoxy composition of Example 1.

This epoxy composition was poured into an aluminum cup, and heated to a temperature of about 100° C., thereby removing the solvent (MEK) to prepare a dried solid.

Then, this dried solid was kept in a vacuum chamber of 150° C. for 10 minutes in a state where it was placed on a glass plate, thereby performing melt defoaming.

A spacer was placed on around this glass plate, and another glass plate was further placed thereon, followed by keeping in a drier of 180° C. for 3 hours. Meanwhile, DGETAM and DHTP-M were allowed to sufficiently react with each other to prepare a tabular cured body (epoxy resin molded article) having a thickness of 0.45 mm.

The thermal conductivity of this cured body was measured. As a result, it was 0.36 W/m·K.

Further, the glass transition temperature thereof was 161° C.

### Example 2

Terephthalylidene-bis-(4-amino-3-methylphenol) diglycidyl ether (DGETAM, epoxy equivalent: 228) and 4,4′,4″-methylidynetrisphenol (TrisP-PHBA, hydroxyl group equivalent: 97) were dissolved in methyl ethyl ketone (MEK) so that the ratio of the number of epoxy groups derived from DGETAM to the number of hydroxyl groups derived from TrisP-PHBA was 1:1 to prepare a solution, and tetraphenylphosphonium tetraphenyl borate was added to the solution so that the ratio thereof to 100 parts by mass of DGETAM was 1 part by mass to prepare an epoxy composition of Example 2.

This epoxy composition was poured into an aluminum cup, and heated to a temperature of about 100° C., thereby removing the solvent (MEK) to prepare a dried solid.

Then, this dried solid was kept in a vacuum chamber of 150° C. for 10 minutes in a state where it was placed on a glass plate, thereby performing melt defoaming.

A spacer was placed on around this glass plate, and another glass plate was further placed thereon, followed by keeping in a drier of 180° C. for 3 hours. Meanwhile, DGETAM and TrisP-PHBA were allowed to sufficiently react with each other to prepare a tabular cured body (epoxy resin molded article) having a thickness of 0.45 mm.

The thermal conductivity of this cured body was measured. As a result, it was 0.35 W/m·K.

Further, the glass transition temperature thereof was 193° C.

Incidentally, the thermal conductivity of the cured body can be determined by a pulse heating method, and can be measured, for example, with a xenon flash analyzer “Type LFA-447” (manufactured by NETZSCH, Inc.). Incidentally, the thermal conductivity of the cured body can be measured by a laser flash method or a TWA method. For example, in the laser flash method, it can be measured using “TC-9000” (manufactured by ULVAC-RIKO, Inc.), and in the TWA method, it can be measured using “ai-Phase Mobile” (manufactured by ai-Phase Co., Ltd.).

Further, the glass transition temperature can be determined as the peak value of tan δ (loss tangent) obtained at the time when dynamic viscoelasticity is measured at a frequency of 1 hertz.

The above reveals that according to the invention, the epoxy resin molded article excellent in thermal conductivity and the epoxy composition suitable for formation of such an epoxy resin molded article can be provided.

The present application is based on Japanese Patent Application No. 2013-017070 filed on Jan. 31, 2013 and Japanese Patent Application No. 2013-017086 filed on Jan. 31, 2013, the contents of which are incorporated herein by reference.

What is claimed is:

1. An epoxy composition comprising:
at least one epoxy monomer selected from the group consisting of epoxy monomers represented by the following general formulae (1) to (4); and
a phenolic curing agent represented by the following general formula (5) or a phenolic curing agent represented by the following general formula (6),
G—X¹—A—X²—G (1)
G—X³—A—X⁴—A′—X⁵—G (2)
G—X⁵—A′—X⁷—A—X⁸—G (3)
G—X⁹—A—X¹⁰—A—X¹¹—G (4)
in which G represents a glycidyloxy group, X¹ to X¹¹ each represents a substituted or unsubstituted phenylene represented by the following general formula (x), and X¹ to X¹¹ may be the same or different from one another, 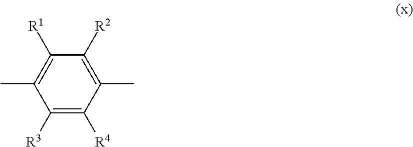
in which R¹ to R⁴ are each a methyl group, an ethyl group, a propyl group or a hydrogen atom, and R¹ to R⁴ may be the same or different from one another, and
further, A and A′ represent azomethine groups represented by the following general formulae (a) and (a′), respectively, 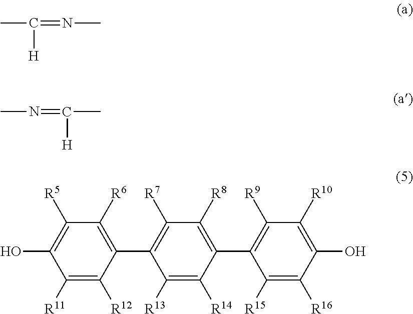
in which R⁵ to R¹⁶ are each a methyl group, an ethyl group, a propyl group or a hydrogen atom, at least one of R⁵ to R¹⁶ is any one of a methyl group, an ethyl group and a propyl group, and R⁵ to R¹⁶ may be the same or different from one another, 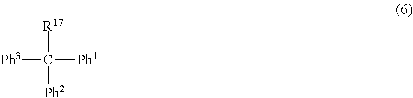
in which R¹⁷ is a hydroxyl group, a methyl group, an ethyl group, a propyl group or a hydrogen atom, Ph¹, Ph² and Ph³ each represents substituted phenyl represented by the following general formula (p), and Ph¹ to Ph³ may be the same or different from one another, 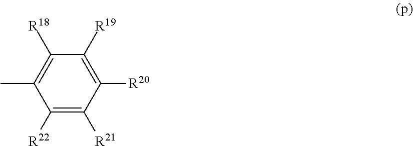
in which R¹⁸ to R²² are each a hydroxyl group, a methyl group, an ethyl group, a propyl group or a hydrogen atom, and at least one of R¹⁸ to R²² is a hydroxyl group.

2. The epoxy composition according to claim 1, further comprising an onium salt-based curing accelerator.

3. The epoxy composition according to claim 1, wherein the epoxy monomer is one represented by the general formula (2), (3) or (4).

4. The epoxy composition according to claim 2, wherein the epoxy monomer is one represented by the general formula (2), (3) or (4).

5. The epoxy composition according to claim 2, wherein the onium salt-based curing accelerator is a phosphonium salt-based curing accelerator.

6. The epoxy composition according to claim 3, wherein the onium salt-based curing accelerator is a phosphonium salt-based curing accelerator.

7. The epoxy composition according to claim 4, wherein the onium salt-based curing accelerator is a phosphonium salt-based curing accelerator.

8. An epoxy resin molded article formed from the epoxy composition according to claim 1.

9. An epoxy resin molded article formed from the epoxy composition according to claim 2.
